(19) United States
(12) Patent Application Publication
(10) Pub. No.: US 2026/0359104 A1
(43) Pub. Date: Nov. 12, 2026

(54) METHOD FOR ORCHESTRATING PROCESS MIGRATION AND RESUMPTION IN A CLOUD COMPUTING INFRASTRUCTURE

(71) Applicant: Cedana AI Inc., New York, NY (US)

(72) Inventors: William Foy, Summerville, SC (US); Brandon Smith, Wichita, KS (US); Niranjan Ravichandra, Washington, DC (US); Neel Master, New York, NY (US)

(21) Appl. No.: 19/064,121

(22) Filed: Feb. 26, 2025

Related U.S. Application Data
(63) Continuation-in-part of application No. 18/957,400, filed on Nov. 22, 2024.
(60) Provisional application No. 63/603,795, filed on Nov. 29, 2023.
(60) Provisional application No. 63/557,977, filed on Feb. 26, 2024.
(60) Provisional application No. 63/705,935, filed on Oct. 10, 2024.

(51) Int. Cl. G06F 9/48; G06F 9/50; G06F 11/34

(52) U.S. Cl. CPC G06F 9/4856; G06F 9/5016; G06F 11/3409

(57) ABSTRACT

A method includes: accessing parameters for a job; accessing performance characteristics for a set of nodes; selecting a first node, in the set of nodes, for execution of a process of the job based on the parameters and the performance characteristics; and scheduling execution of the process at the first node. In response to updated parameters for the job prior to completion of the job, the method includes: accessing updated performance characteristics for the set of nodes; selecting a second node, in the set of nodes, for the first process based on the updated parameters and the updated performance characteristics; recording a state of the process executing at the first node; restoring the state of the process at the second node; terminating execution of the process at the first node; and resuming execution of the process at the second node according to the state.

### CROSS-REFERENCE TO RELATED APPLICATIONS

This Application is a continuation-in-part of U.S. patent application Ser. No. 18/957,400, filed on 22-NOV-2024, which claims the benefit of U.S. Provisional Application No. 63/603,795, filed on 29-NOV-2023, each of which is incorporated in its entirety by this reference.

This Application claims the benefit of U.S. Provisional Application No. 63/705,935, filed on 10-OCT-2024, and of U.S. Provisional Application No. 63/557,977, filed on 26-FEB-2024, each of which is incorporated in its entirety by this reference.

### TECHNICAL FIELD

This invention relates generally to the field of cloud computing and, more specifically, to a new and useful method for orchestrating process migration and resumption in a cloud computing infrastructure within the field of cloud computing.

### BRIEF DESCRIPTION OF THE FIGURES

FIG. 1 is a flowchart representation of a method;

FIG. 2 is a flowchart representation of one variation of the method;

FIGS. 3A, 3B, and 3C are flowchart representations of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

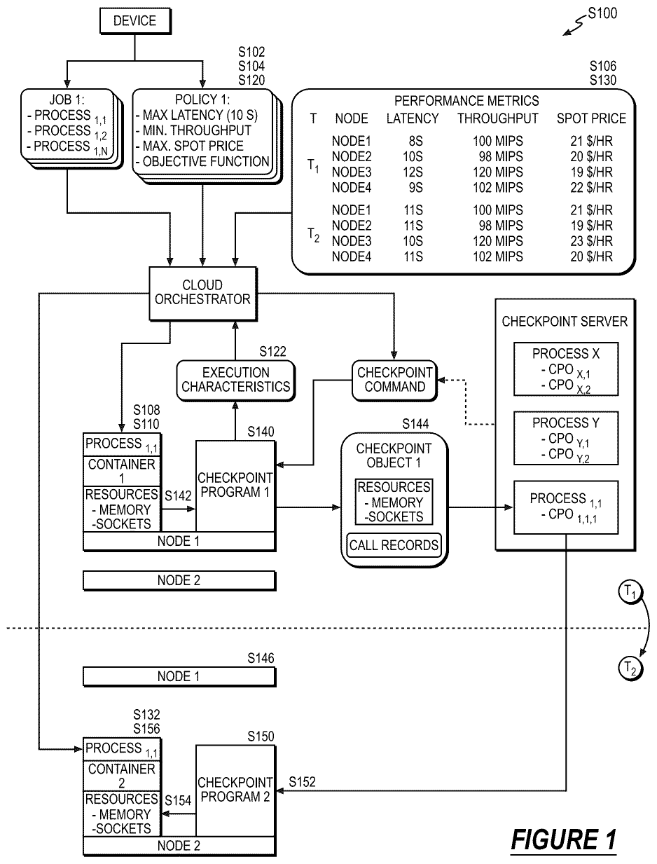

As shown in FIGS. 1, 2, 3A, 3B, and 3C, a method S100 includes, during a first time period: accessing a first policy for a job including a first process in Block S102, the first policy defining a first set of parameters and a first objective function; accessing a first set of performance characteristics representing a population of nodes for a first time interval in Block S106; selecting a first node, in the population of nodes, for the first process based on the first set of parameters, a first subset of performance characteristics —in the first set of performance characteristics-for the first node, and the first objective function in Block S108; and scheduling execution of the first process at the first node in Block S110.

The method S100 also includes, during a second time period succeeding the first time period: accessing a second policy for the job in Block S120, the second policy defining a second set of parameters and a second objective function; accessing a second set of performance characteristics representing the population of nodes for a second time interval in Block S130; and selecting a second node, in the population of nodes, for the first process based on the second set of parameters, a second subset of performance characteristics—in the second set of performance characteristics—for the second node, and the second objective function in Block S132.

The method S100 further includes, in Block S140, triggering a first checkpoint program executing at the first node: to record a first state of the first process executing at the first node in Block S142; and to generate a first checkpoint object representing the first state of the first process at the first time in Block S144. The first state: represents a first set of resources in the first node allocated to the first process at a first time; and includes a first set of data stored in a first memory in the first set of resources.

The method S100 also includes, in Block S150, triggering a second checkpoint program executing at the second node: to access the first checkpoint object in Block S152; and to restore the first state of the first process at a second set of resources in the second node by loading the first set of data into a second memory in the second node in Block S154.

The method S100 further includes: terminating execution of the first process and the first checkpoint program at the first node in Block S146; and scheduling resumption of the first process at the second node based on the first set of data loaded into the second memory in Block S156.

### 1.1 Variation: Multiple Jobs According to Multiple Policies

As shown in FIGS. 1, 2, 3A, 3B, and 3C, one variation of the method S100 includes, during a first time period: accessing a first set of parameters for a first job in Block S102; accessing a second set of parameters for a second job in Block S104; and accessing a first set of performance characteristics representing a set of nodes for a first time interval in Block S106.

This variation of the method S100 also includes, based on the first set of parameters, the second set of parameters, and the first set of performance characteristics, calculating a first assignment of workloads to nodes in the set of nodes in Block S108 by: selecting a first node, in the set of nodes, for a first process of the first job; and selecting a second node in the set of nodes for a second process of the second job.

This variation of the method S100 further includes: scheduling execution of the first process at the first node in Block S110; and scheduling execution of the second process at the second node in Block S112.

This variation of the method S100 also includes, during a second time period succeeding the first time period: accessing a third set of parameters for the second job in Block S120; accessing a second set of performance characteristics representing the set of nodes for a second time interval in Block S130; and, based on the first set of parameters, the third set of parameters, and the second set of performance characteristics, calculating a second assignment of workloads to nodes in the set of nodes by selecting the first node for a third process of the second job in Block S132.

This variation of the method S100 further includes, at a first checkpoint program executing at the first node: recording a first state of the first process executing at the first node in Block S142; and generating a first checkpoint object representing the first state of the first process at a first time in Block S144. The first state: represents a first set of resources in the first node allocated to the first process at the first time; and includes a first set of call records representing a first set of calls to a first application programming of a first graphics processing unit in the first node.

This variation of the method S100 also includes, at a second checkpoint program executing at the first node: accessing a second checkpoint object representing a second state of the third process at a second time and including a second set of call records representing a second set of calls in Block S152; and restoring the second state of the third process at a second set of resources in the first node by executing the second set of calls to a second application programming interface of a second graphics processing unit in the first node in Block S154.

This variation of the method S100 further includes: terminating execution of the first process and the first checkpoint program at the first node in Block S146; and scheduling resumption of the third process at the first node in response to executing the second set of calls in Block S156.

### 1.2 Variation: Policy Change

As shown in 1, 2, 3A, 3B, and 3C, one variation of the method S100 includes: accessing a first set of parameters for a model training job including a first process in Block S102; accessing a first set of performance characteristics representing a population of nodes for a first time interval in Block S106; selecting a first node, in the population of nodes, for the first process based on the first set of parameters and a first subset of performance characteristics-in the first set of performance characteristics-for the first node in Block S108; and scheduling execution of the first process at the first node in Block S110.

This variation of the method S100 also includes, in response to a change from the first set of parameters to a second set of parameters—different from the first set of parameters—for the model training job: accessing a second set of performance characteristics representing the population of nodes for a second time interval in Block S130; and, prior to completion of the model training job, selecting a second node, in the population of nodes, for the first process based on the second set of parameters and a second subset of performance characteristics, in the second set of performance characteristics, for the second node in Block S132.

This variation of the method S100 further includes, in Block S140, triggering the first node: to record a first state of the first process executing at the first node, the first state representing a first set of resources in the first node allocated to the first process at a first time in Block S142; and to generate a first checkpoint object representing the first state of the first process at the first time in Block S144.

This variation of the method S100 also includes, in Block S150, triggering the second node to: access the first checkpoint object in Block S152; and restore the first state of the first process at a second set of resources in the second node in Block S154.

This variation of the method S100 further includes scheduling resumption of the first process at the second node based on the first state of the first process in Block S156.

### 1.3 Variation: Remote Contract Computing Network

As shown in FIG. 1, one variation of the method S100 includes, during a first time period: accessing a policy associated with a first process and defining a set of parameters in Block S102; accessing a first set of performance characteristics associated with a population of nodes during a first time interval in Block S106; selecting a first node, in the population of nodes and associated with a first remote contract computing network, based on the set of parameters and a first subset of performance characteristics, in the first set of performance characteristics, associated with the first node in Block S108; and scheduling execution of the first process at the first node in Block S110.

The method S100 also includes, during a second time period succeeding the first time period, accessing a second set of performance characteristics associated with the population of nodes during a second time interval in Block S130.

The method S100 further includes, in response to a second subset of performance characteristics, in the second set of performance characteristics and associated with the first node, falling below the first set of parameters: capturing a first state of the first process in Block S142; generating a first checkpoint object representing the first state of the first process in Block S144; and transmitting the first checkpoint object to a checkpoint server.

The method S100 also includes: selecting a second node, in the population of nodes and associated with a second remote contract computing network, based on the set of parameters and a third subset of performance characteristics, in the second set of performance characteristics, associated with the second node in Block S132; transmitting the first checkpoint object from the checkpoint server to a checkpoint program instantiated on the second node in Block S152; and restoring the first state of the first process on resources of the second node in Block S154.

### 2. Applications

Generally, a computer system (hereinafter “the system”)—including or interfacing with a cloud infrastructure and/or a checkpoint server—can execute Blocks of the method S100: to access a policy (e.g., a service level agreement, objectives) for a job (e.g., a model training job, an inference job); to characterize real-time performance of nodes within the cloud infrastructure; and to select a first node of the cloud infrastructure —such as a first node (e.g., a preemptible node, a “spot” node) associated with a first cloud provider (or “remote contract computing network”) or a first node in a private cluster of nodes—based on the policy and real-time performance characteristics of the first node in order to schedule execution of a process of the job. The system can execute Blocks of the method S100: to checkpoint a state of the process executing on the first node; to migrate the process from the first node to a second node in the cloud infrastructure—such as a second node associated with a second cloud provider or a second node in the private cluster of nodes-based on real-time performance of the first node and the second node; and to resume the process by restoring the state onto resources of the second node.

Therefore, the system can enable fine-grained (e.g., near-real-time) checkpoint, migration, and resumption functionality across nodes associated with different cloud service providers or within the private cluster of nodes, thereby increasing a quantity of eligible nodes to which the process may be deployed and executed-based on time-varying performance of these nodes-according to the policy.

More specifically, the system can execute Blocks of the method S100: to detect (or generate) a set of real-time performance characteristics (e.g., latency, performance capacity, throughput, error rate, availability, spot price) for each node in a population of nodes across a set of cloud service providers; to select the first node in the population of nodes based on an objective function, parameters defined in the policy, and a first set of real-time performance characteristics of the first node; to generate a first workload instance on the first node; to deploy a checkpoint program and a process of the job on the first workload instance; and to monitor, via the checkpoint program, execution of the process on the first node.

At a future time, the system can execute Blocks of the method S100: to detect (or generate) an updated set of real-time performance characteristics for each node in the population of nodes; to select a second node of the cloud infrastructure based on the objective function, the parameters, and a second set of real-time performance characteristics of the second node; and to migrate the process from the first node to the second node.

More specifically, the system can execute Blocks of the method S100: to pause execution of the process at a target time; to identify resources of the first node allocated to the process at the target time; to capture-via the checkpoint program-a state of the process at the target time based on the these resources; to generate a checkpoint object representing the state of the process of the target time; and to terminate the first workload instance on the first node. Then, the system can execute Blocks of the method S100: to generate a second workload instance on the second node; to access the checkpoint object representing the state of the process of the target time; to deploy the checkpoint program, the process, and the checkpoint object on the second workload instance; to restore the state of the process on resources of the second node; and to resume execution of the process.

Therefore, rather than waiting until completion of the job at the first node (or terminating the job at the first node and restarting execution of the job-from a beginning of the job-at the second node), the system can execute Blocks of the method S100 to selectively pause and resume execution of processes of the job on different nodes based on time-varying performance of nodes and/or time-varying policies for the job, thereby optimizing deployment and execution (e.g., completion time) of the job within the cloud infrastructure.

Additionally, the system can execute Blocks of the method S100: to access execution characteristics of a process; to detect a deviation between these execution characteristics and the parameters defined in the policy; and to adjust the parameters in the policy in order to compensate for this deviation. The system can then execute Blocks of the method S100: to reassign processes to nodes according to adjusted parameters in the policy and real-time characteristics of these nodes; and to selectively pause, migrate, and resume the processes at target nodes.

### 2.x Example: Migration During Node Downtime

In one example application, the system executes Blocks of the method S100: to receive a policy specifying 99% reliability for a web services job; to characterize real-time performance of nodes within the cloud infrastructure; to select a first node of the cloud infrastructure based on the policy and real-time performance characteristics of the first node in order to schedule execution of a process of the web services job; to checkpoint a state of the process executing on the first node in response to schedule downtime (e.g., hardware update, software kernel update) of the first node; to migrate the process from the first node to a second node in the cloud infrastructure based on real-time performance of the second node; and to resume the process by restoring the state onto resources of the second node.

Therefore, the system executes Blocks of the method S100 to maintain 99% reliability for the web services job according to policy by executing a checkpoint, migration, and resumption routine—absent modification to the process of the web services job and absent modification to the first and second nodes-during the scheduled downtime of the first node.

### 3. Terminology

Generally, a “job” is referred to herein as a first unit of work—received from a device—including a set of processes for execution.

Generally, a “process” is referred to herein as an instance of a program represented by a memory space, a file descriptor, and/or a process identifier (or a “PID”).

Generally, a “program” is referred to herein as set of instructions executable by a computer.

Generally, a “container” is referred to herein as an isolated runtime environment.

Generally, “checkpoint” is referred to herein as capturing a state of a set of resources allocated to (or utilized by) a process executing at a node.

Generally, “preemptible node” is referred to herein as a node (e.g., a “spot” node) that is allocated by a provider (e.g., a remote contract computing network) based on surplus capacity and that is interruptible by the provider when demand increases.

### 4. System

Generally, as shown in FIG. 1, the system can include and/or interface with: a device (e.g., a user device, an enterprise device); a cloud computing subsystem (hereinafter “the cloud subsystem”) communicatively coupled to the device via a communication network (e.g., e.g., a local area network, a wide area network, the Internet); and a checkpoint server communicatively coupled to the cloud subsystem via the communication network.

The system can include additional devices communicatively coupled to the cloud subsystem via the communication network.

### 4.1 Cloud Subsystem

Generally, the cloud subsystem can include and/or interface with: a population of nodes (e.g., computing devices, bare-metal servers); and a cloud orchestrator (e.g., a computing device).

In one implementation, the population of nodes can include a heterogenous population of nodes. More specifically, the population of nodes can include a heterogenous population of nodes associated with a set of remote contract computing networks.

For example, the population of nodes can include: a first set of nodes associated with a first remote contract computing network; and a second set of nodes associated with a second remote contract computing network. In this example, the first set of nodes can include: a first subset of nodes located in a first geographic region (e.g., a first country); and a second subset of nodes located in a second geographic region (e.g., a second country).

In another implementation, the cloud subsystem receives a request—from the device—to execute a job (e.g., an inference job, a model training job, a rendering job, a gaming application) including a set of processes. In response to receiving the request, the cloud subsystem: executes the job; and returns a result to the device (or queues the result for download).

More specifically, the cloud orchestrator can: receive the job from the device; and schedule execution of a first process—in the set of processes—at a first node in the population of nodes. The first node can then execute the first process. For each process in the set of processes, the cloud subsystem can repeat the foregoing methods and techniques: to schedule execution of the process at a node (e.g., the first node, a second node) in the population of nodes; and to execute the process on the node.

Additionally, the cloud subsystem can monitor execution of a process on a node. For example, the cloud orchestrator can receive a set of execution characteristics representing a set of resources allocated to (or utilized by) the process executing at the node.

The cloud subsystem can return a result to the device in response to completion of the job.

### 4.1.1 Resource Cost

In one implementation, the cloud orchestrator can calculate a total cost attributed to execution of the first process on resources of the node.

For example, the cloud orchestrator can calculate the total cost based on: an amount of resources (e.g., processing capacity, memory capacity, I/O bandwidth, execution time) in the node allocated to the first process; and a cost of resources of the node based on demand and/or locality of the node.

### 4.2 Checkpoint Program

In one implementation, the system includes a checkpoint program (or “daemon”) executing on a node in the population of nodes. For example, the node can execute the checkpoint program as a background process.

In another implementation, the checkpoint program: instantiates (or executes) at a node in the population of nodes; attaches to a process executing at the node; and monitors execution of the process at the node.

For example, the checkpoint program can: generate a set of execution characteristics representing resources allocated to the process during execution; and transmit the set of execution characteristics to the cloud orchestrator and/or the checkpoint server.

In this implementation, in response to receiving a checkpoint command (e.g., a remote procedure call), the checkpoint program: records state information associated with the process (or a “process state”); generates a checkpoint object representing the state information; and transmits the checkpoint object to the checkpoint server.

### 4.3 Checkpoint Server

Generally, the checkpoint server stores a population of checkpoint objects, each checkpoint object associated with a process in a population of processes. More specifically, the checkpoint server can store a group of checkpoint objects associated with a process in a set of processes representing a job.

In one implementation, the checkpoint server includes a data repository storing the set of checkpoint objects.

Additionally or alternatively, the checkpoint server can store the set of checkpoint objects in an external data repository (e.g., a remote data repository).

In another implementation, the checkpoint server communicates with a checkpoint program executing on a node. For example, the checkpoint server can transmit commands (e.g., remote procedure calls) to a checkpoint program executing at a node, such as: a first command to record a state of a process executing at the node as a checkpoint object; and a second command to restore the state of the process—extracted from the checkpoint object stored at the checkpoint server—at a target node.

### 5. Policies

Block S102 of the method S100 recites accessing a first policy for the job, the first policy defining a first set of parameters and a first objective function.

Block S104 of the method S100 recites accessing a second set of parameters for a second job.

Generally, in Blocks S102 and S104, the cloud orchestrator can: access a job including a set of processes; and access a policy—associated with the job (or a set of jobs) —specifying rules for deployment and execution of the job within the cloud subsystem.

More specifically, the cloud orchestrator can access the policy including a set of parameters corresponding to a set of target performance characteristics and representing orchestration rules for the job (and/or processes of the job).

For example, the cloud orchestrator can access the policy defining a target configuration for the job and/or for a process of the job. The target configuration can represent a set of parameters (e.g., resource parameters, price parameters, cost parameters) for executing the process.

In one implementation, the cloud orchestrator receives the policy from the device associated with the job. For example, the cloud orchestrator can: receive a first policy file, associated with a first set of jobs, via an application programming interface; and extract a first set of parameters for the first set of jobs from the first policy file.

In another implementation, the cloud orchestrator: receives a policy document specifying a set of objectives associated with a job (e.g., minimize response time, minimize total cost, maximize performance, minimize power consumption); extracts the set of objectives from the policy documents; generates a set of parameters and an objective function based on the set of objectives; and generates a policy including the set of parameters and the objective function.

More specifically, the cloud orchestrator can: parse the policy document; detect a set of language signals, in the policy document, corresponding to the set of objectives; access a model (e.g., a large-language model) that correlates language signals with parameters; and, based on the model, correlate the set of language signals with the set of parameters.

In yet another implementation, the cloud orchestrator: receives a set of selections, via a user interface at the device, representing a set of parameters and/or a set of objectives associated for a job; and generates a policy—including the set of parameters and an objective function—based on the set of selections.

In yet another implementation, the cloud orchestrator generates a set of template policies associated with a set of job types (e.g., a model training job, an inference job, a scientific computing job, a web services job).

For example, the cloud orchestrator can generate the set of template policies including a model training job template policy defining: a first set of template parameters corresponding to a first set of target performance characteristics for a model training job; and a first template objective function that minimizes total cost for assigning the job to a node(s).

In this example, the cloud orchestrator can generate the set of template policies including an inference job template policy defining: a second set of template parameters corresponding to a second set of target performance characteristics for an inference job; and a second template objective function that minimizes response time for the job and maximizes availability (or reliability) of a node(s) assigned the job.

In this implementation, the cloud orchestrator receives a selection of a template policy, in the set of template policies, via the user interface at the device; and generates a policy-including a set of parameters-based on the selection.

Additionally, the cloud orchestrator can: receive a set of selections, from the user interface, representing a set of modifications to the set of template parameters and/or the template objective function; and modifies the policy and/or the set of parameters based on the set of selections.

For example, the cloud orchestrator can: access an inference job template policy defining a first set of template parameters-including a first target response time (e.g., 600 millisecond maximum response time) for the job- and a template objective function that maximizes availability (or reliability) of a node(s) assigned the job; generate a visualization representing the first set of template parameters, such as a first slider position representing the first target response time for the job; and serve the visualization to a user via the user interface.

In this example, the cloud orchestrator can: access a set of modifications to the set of template parameters from the user via the user interface, such as a second slider position representing a second target response time (e.g., 500 millisecond maximum response time) for the job; transform the first set of template parameters into a transformed set of parameters—including the second target response time—based on the set of modifications; based on the transformed set of parameters, generate an objective function that maximizes availability (or reliability) of a node(s) assigned the job and minimizes response time for the job; and generate a policy defining the transformed set of parameters and the objective function.

Therefore, the cloud orchestrator can assist the user in customizing a policy for deployment and execution of the job within the cloud subsystem according to specific needs and/or objectives of the user.

### 5.1 Parameters

In one implementation, the cloud orchestrator can access the policy defining a target configuration representing a set of parameters—corresponding to a set of target performance characteristics and representing orchestration rules for the job such as: a target processor capacity (e.g., a target central processing unit processing capacity, a target graphics processing unit processing capacity); a target processor throughput (e.g., central processing unit throughput, graphics processing unit throughput); a target processor utilization (e.g., a target central processing unit utilization, a target graphics processing unit utilization); a target processor type (e.g., a target central processing unit type, a target graphics processing unit type); a target processor interconnect; a target memory capacity (e.g., a target memory size, a target memory bandwidth); a target memory type; a target memory throughput; a target network interconnect; a target network bandwidth; a target network throughput; a target error rate; a target storage capacity; a target availability; a target latency; a target response time; a target locality (e.g., a target region, a target country); target security features (e.g., encryption, hardware security module); target regulatory features (e.g., privacy compliance); a target price (e.g., a target node spot price, a target node projected price, a target storage price); a target egress fee; and/or a target total cost; etc. The cloud orchestrator can access the policy defining a set of values (e.g., a target value, a maximum value, a minimum value, an average value) for each parameter in the set of parameters. Additionally, the cloud orchestrator can access the policy including the set of parameters defining a frequency (e.g., once per second, once per minute) at which to generate a checkpoint object for the job. The cloud orchestrator can access the policy defining a rank (or a priority) for each parameter in the set of parameters.

In one example, the cloud orchestrator accesses a first policy—associated with a model training job—defining a first set of parameters including: a first parameter, representing a first maximum spot price (e.g., three dollars per graphics processing unit per hour), exhibiting a first priority; a second parameter, representing a first reliability value (e.g., 75% reliability), exhibiting a second priority falling below the first priority; a third parameter, representing a first maximum response time (or maximum completion time) (e.g., one week), exhibiting a third priority falling below the second priority; and a fourth parameter representing a first frequency (e.g., once per minute) at which to generate a checkpoint object for the model training job.

In another example, the cloud orchestrator accesses a second policy—associated with an inference job—defining a second set of parameters including: a fifth parameter, representing a second minimum reliability value (e.g., 99% reliability), exhibiting a fourth priority; a sixth parameter, representing a second maximum response time (e.g., one minute), exhibiting a fifth priority falling below the fourth priority; a seventh parameter, representing a second maximum spot price (e.g., ten dollars per graphics processing unit per hour), exhibiting a sixth priority falling below the fifth priority; and an eighth parameter representing a second frequency (e.g., once per second) at which to generate a checkpoint object for the inference job.

### 6. Node Profiling

Block S106 of the method S100 recites accessing a first set of performance characteristics representing a population of nodes for a first time interval.

Generally, in Block S106, the cloud orchestrator can access (or monitor) a set of performance characteristics associated with the population of nodes for a target time interval. More specifically, for each node in the population of nodes, the cloud orchestrator can detect (or access) a subset of performance characteristics, in the set of performance characteristics, associated with the node during the target time interval.

In one implementation, the cloud orchestrator detects the subset of performance characteristics for the node, such as: a central processing unit processing capacity; a central processing unit throughput; a central processing unit type; a graphics processing unit processing capacity; a graphics processing unit throughput; a graphics processing unit type; a processor interconnect; a memory capacity (e.g., a memory size, a memory bandwidth); a memory type; a memory throughput; a network interconnect; a network bandwidth; a network throughput; an error rate; a storage capacity; an availability; a latency; a response time; a locality (e.g., a local time, a region, a country); security features (e.g., encryption, hardware security module); regulatory features (e.g., privacy compliance); a price (e.g., a spot price, a projected price); an egress fee; and/or a cost; etc. The cloud orchestrator can define a set of values (e.g., a maximum value, a minimum value, an average value) for each performance characteristic in the subset of performance characteristics.

For example, the cloud orchestrator can detect the subset of performance characteristics based on data received from a remote contract computing network. More specifically, the cloud orchestrator accesses the subset of performance characteristics via an application programming interface of a remote contract computing network associated with a node. The cloud orchestrator can periodically poll the application programming interface for the subset of performance characteristics. Additionally or alternatively, the cloud orchestrator can automatically receive the performance characteristic via the application programming interface at a predefined frequency (e.g., once per second, once per minute).

Additionally or alternatively, the cloud orchestrator can: receive execution characteristics representing performance of the node during execution of a process scheduled at the node by the cloud orchestrator (or another system); and detect (or calculate) the subset of performance characteristics based on the execution characteristics.

Additionally or alternatively, the cloud orchestrator can: access historical data representing performance of the node during a time interval (or a set of time interval) preceding the target time interval; and detect the subset of performance characteristics—associated with the node during the target time period—based on the historical data.

Accordingly, the cloud orchestrator can characterize current, real-time (and/or future) performance and cost of each node in a population of nodes, such as a heterogeneous population of nodes associated with a set of disparate remote contract computing networks. Therefore, the cloud orchestrator can optimize deployment of workloads across these nodes at different times based on fluctuations in performance and/or cost.

For example, the cloud orchestrator can characterize a cost of a target node at a future time based on a set of factors including: an egress fee of the target node; a difference between a future cost of the target node (i.e., at the future time) and a current cost of the target node; and/or a storage cost of a state of a job to be executed on the target node at the future time; etc. In this example, the cloud orchestrator can apply a weight to each factor in the set of factors.

### 6.1 Real-Time Execution Characteristics

In one implementation, the cloud orchestrator: receives a set of execution characteristics representing resources allocated to (or utilized by) a process (e.g., a process associated with a requested job, a test process) executing on a node, in the population of nodes, during a target time interval; and generates a performance characteristic(s), in the subset of performance characteristics, based on the set of execution characteristics.

For example, the cloud orchestrator can: receive a first set of execution characteristics representing a current processor utilization of a first node based on execution of a first process on the first node during a first time interval; and generate a first subset of performance characteristics-associated with the first node during the first time interval-based on the first set of execution characteristics.

The cloud orchestrator can repeat the foregoing methods and techniques at a predefined frequency (e.g., once per second, once per minute): to receive an updated set of execution characteristics at a predefined frequency; and to generate an updated subset of performance characteristics-associated with the first node—based on the updated set of execution characteristics.

In another implementation, for each subset of performance characteristics generated based on a set of execution characteristics responsive to execution of a process of a job, the cloud orchestrator: associates the subset of performance characteristics with a timestamp (e.g., a target time interval) and a process type (e.g., a convolution layer, a pooling layer, a compute-intensive process, a memory-intensive process)—corresponding to the process—and/or a job type (e.g., an inference job, a model training job, a rendering job, a gaming application) corresponding to the job; and stores the subset of performance characteristics (and/or the set of execution characteristics) in a data repository.

### 6.2 Historical Data

In one implementation, the cloud orchestrator: accesses a set of historical data representing performance of a node during a first time interval preceding a second time interval; and generates a subset of performance characteristics—associated with the node during the second time interval—based on the set of historical data.

In one example, for a second time interval (e.g., Tuesday from 12:00 pm to 12:01 pm), the cloud orchestrator: accesses a first subset of performance characteristics exhibited by a first node during a first time interval (e.g., Monday from 12:00 pm to 12:01 pm), preceding the second time interval, based on similarity between the first time interval and a second time interval; and generates a second subset of performance characteristics—associated with the first node during the second time interval—based on the first subset of performance characteristics.

In another example, for a second time interval, the cloud orchestrator: receives a second process, associated with a second process type (e.g., convolution layer), for execution; accesses a third subset of performance characteristics—exhibited by a second node during execution of a first process, associated with a first process type (e.g., convolution layer), in a first time interval preceding the second time interval—based on similarity between the first process type and the second process type; and generates a fourth subset of performance characteristics, associated with the second node during the second time interval, based on the third subset of performance characteristics.

### 7. Orchestration

Block S108 of the method S100 recites, based on the first set of parameters, the second set of parameters, and the first set of performance characteristics, calculating a first assignment of workloads to nodes in the set of nodes by: selecting a first node in the set of nodes for a first process of the first job; and selecting a second node in the set of nodes for a second process of the second job.

The method S100 includes: scheduling execution of the first process at the first node in Block S110; and scheduling execution of the second process at the second node in Block S122.

Generally, in Blocks S108, S110, and S112, the system can: calculate an assignment of workloads—representing processes of jobs—to nodes in the population of nodes based on policies of the jobs and real-time performance characteristics of the nodes; instantiate these workloads onto nodes according to the assignment; and schedule execution of the workloads at the nodes.

More specifically, during a first time period, the cloud subsystem can: select a first process in a set of processes of a job received from the device; identify a first node —in the population of nodes—at which to schedule the first process, such as based on a first set of parameters of the job and a first subset of performance characteristics associated with the first node for a first time interval; instantiate (or execute) a first checkpoint program at the first node; schedule execution of the first process at the first node; and execute the first process on the first node.

### 7.1 Workload Assignment

In one implementation, the cloud orchestrator: accesses a first job including a set of processes, the set of processes including a first process; and accesses a first policy for the first job in Block S102. The first policy defines a first set of parameters and a first objective function for the first job (and/or the first process).

In this implementation, the cloud orchestrator: accesses a set of performance characteristics representing a population of nodes for a time interval in Block S106; and selects a first node in the population of nodes for the first process based on the first set of parameters, a first subset of performance characteristics-in the set of performance characteristics-for the first node, and the first objective function in Block S108.

For example, the cloud orchestrator can: access the first policy defining the first set of parameters including a target response time for the first job; and access the first subset of performance characteristics representing a central processing unit processing capacity of the first node, a central processing unit of the first node, a graphics processing unit processing capacity of the first node, a graphics processing unit processing utilization of the first node a network throughput of the first node, and a locality of the first node, etc.

In this example, the cloud orchestrator can calculate a first estimated response time—in a set of estimated response times—for the first job at the first node based on the first subset of performance characteristics.

The cloud orchestrator can repeat the foregoing methods and techniques for each node in the population of nodes: to access a subset of performance characteristics for the node; and to calculate an estimated response time—in the set of estimated response times—for the first job at the node based on the subset of performance characteristics.

In this example, the cloud orchestrator can select the first node for the first process in response to: the first estimated response time falling below (all) other estimated response times in the set of estimated response times; and the first estimated response time falling below the target response time for the first job.

More specifically, the cloud orchestrator can select the first node for the first process in response to identifying the first estimated response time as the shortest estimated response time in the set of estimated response times.

Additionally, the cloud orchestrator can select the first node at which to schedule the first process in response to correspondence between the first subset of performance characteristics of the first node and the target configuration—representing the set of parameters corresponding to the set of target performance characteristics—for the first process.

For example, the cloud subsystem can: access the target configuration corresponding to a set of target performance characteristics; access the first subset of performance characteristics of the first node; and select the first node in response to the first set of performance characteristics falling within the set of parameters corresponding to the set of target performance characteristics.

The cloud orchestrator can repeat the foregoing methods and techniques for each job in a set of jobs received at the cloud orchestrator: to access a process of the job; to access a policy defining a set of parameters and an objective function for the job; and to select a node in the population of nodes for the process based on the set of parameters, a subset of performance characteristics—in the set of performance characteristics—for the node, and the objective function.

For example, the cloud orchestrator can: access a second process of a second job; and access a second policy defining a second set of parameters and a second objective function for the job. Additionally, the cloud orchestrator can access the first policy defining a first set of parameters and a first objective function for the first job.

In this example, the cloud orchestrator can select a second node in the population of nodes for the second process based on: the first set of parameters, the second set of parameters, the first objective function, the second objective function, and the set of performance characteristics (e.g., the first subset of performance characteristics for the first node, the second subset of performance characteristics for the second node).

### 7.2 Scheduling and Execution

Generally, in Blocks S110 and S112, in response to selecting a node for a process of a job, the cloud orchestrator can: instantiate the process and a checkpoint program on the node; attach the checkpoint program to the process; and schedule execution of the process at the node, such as described in U.S. patent application Ser. No. 18/957,400.

In one implementation, the cloud orchestrator: selects a first node—in the population of nodes—at which to schedule the first process; instantiates (or executes) a first checkpoint program at the first node; allocates resources in the first node to the first process; and schedules execution of the first process at the first node in Block S110.

More specifically, the cloud orchestrator (or the first node) can: instantiate the first checkpoint program as a background process executing at the first node; and attach the first checkpoint program to the first process identified by a first process identifier.

In another implementation, the first checkpoint program queries the checkpoint server for a checkpoint object associated with the first process.

For example, the checkpoint program can transmit a first message requesting a checkpoint object associated with the first process identifier. In this example, the checkpoint server can transmit a second message indicating absence of a checkpoint object associated with the first process identifier.

The first node can then execute the first process.

### 7.2.1 Workload Monitoring

In another implementation, the first checkpoint program derives a set of execution characteristics representing resources allocated to the first process during execution at the first node. For example, the first checkpoint program can derive the set of execution characteristics representing: a current processor utilization attributed to execution of (or allocated to) the first process; and/or a current network throughput attributed to execution of the first process. The first checkpoint program transmits the set of execution characteristics to the cloud orchestrator and/or the checkpoint server.

The checkpoint program can periodically generate and transmit a set of execution characteristics according to a predefined frequency (e.g., once per second, once per ten seconds, once per minute).

### 7.2.2 Call Interception

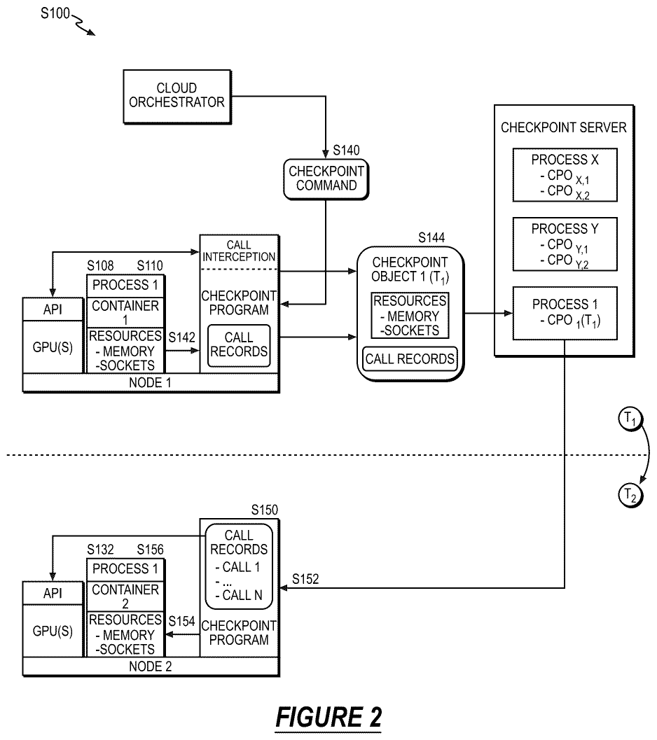

Generally, as shown in FIG. 2, a checkpoint program can track a set of calls—by a process executing on a central processing unit of a node—to an application programming interface (e.g., a runtime application programming interfacing, a driver application programming interfacing) of a graphics processing unit (or a set of graphics processing units) of a node. For each call in the set of calls, the checkpoint program can: intercept the call to the application programming interface of the graphics processing unit; generate a call record—in a set of call records—representing the call; and pass the call to a controller of the graphics processing unit for execution.

In one implementation, the first checkpoint program executing at the first node: tracks a set of calls by the first process to a first application programming interface (e.g., a runtime application programming interface) of a first graphics processing unit in the first node; and tracks a set of memory operations (storage of data onto graphics processing unit memory, release of data from graphics processing unit memory)—associated with the first process—between a first central processing unit and the first graphics processing unit of the first node.

For example, the first checkpoint program can: intercept a first call to the runtime application programming interface of the first graphics processing unit by the first process; detect a first subset of memory operations associated with the first call; and generate a first call record representing the first call and the first subset of memory operations.

The first checkpoint program can pass the first call to a first controller of the first graphics processing unit for execution.

The first checkpoint program can repeat the foregoing methods and techniques for each call to the first application programming interface of the first graphics processing unit (and/or to an application programming interface(s) of another graphics processing unit(s)) during execution of the first process to generate a set of call records representing: the set of calls by the first process during a first time period; and the set of memory operations associated with the set of calls.

Accordingly, the cloud orchestrator can: instantiate the first checkpoint program at the first node; attach the first checkpoint program to the first process; and trigger the first checkpoint program to track calls- and memory operations associated with these calls—to the first application programming interface of the first graphics processing unit for storage in a checkpoint object. Therefore, the system can later execute these calls and memory operations stored in the checkpoint object in order to restore a state of the graphics processing unit(s) at a target node.

### 7.2.3 Process Checkpointing

In one implementation, the system can execute similar methods and techniques described in U.S. Provisional Application No. 63/603,795 to periodically checkpoint the first process at a predefined frequency (e.g., defined in the first set of parameters).

For example, the system (e.g., the cloud orchestrator, the checkpoint server) can transmit a command (or a “checkpoint command”)—to the first checkpoint program —to checkpoint the first process based on a schedule associated with the first process. The schedule can define a frequency (e.g., once per ten seconds, once per minute, once per hour) at which to transmit a checkpoint command to the first checkpoint program.

In response to receiving the command to checkpoint the first process, the first checkpoint program: records a current state of the first process executing on the first node; generates a checkpoint object representing the current state of the first process; and transmits the checkpoint object to the checkpoint server (or another data repository).

More specifically, the first checkpoint program can record the current state of the first process executing at the first node, the current state: representing a set of resources in the first node allocated to the first process at a target time; and including the set of call records at the target time.

In one example, the first checkpoint program records the current state, including a set of data stored in memory (e.g., processor registers, memory address space) of the first node and allocated to the first process.

In this example, the first checkpoint program records the current state including: a first subset of data stored in a first set of processor registers in the set of resources allocated to the first process; and a second subset of data stored in a first memory device (e.g., an L1 cache, an L2 shared memory) in the set of resources allocated to the first process.

In another example, the first checkpoint program records the current state representing: a set of file descriptors associated with the first process; a set of file connections associated with the first process; and/or a set of network connections associated with the first process.

In response to checkpointing the first process, the first node can continue executing the first process.

### 8. Process Migration

The method S100 includes: accessing a third set of parameters for the second job in Block S120; and accessing a second set of performance characteristics representing the set of nodes for a second time interval in Block S130.

Block S132 of the method S100 recites, based on the first set of parameters, the third set of parameters, and the second set of performance characteristics, calculating a second assignment of workloads to nodes in the set of nodes by selecting the first node for a third process of the second job.

Block S140 of the method S100 recites triggering a first checkpoint program executing at the first node to: record a first state of the first process executing at the first node, the first state—representing a first set of resources in the first node allocated to the first process at a first time—including a first set of data stored in a first memory in the first set of resources in Block S142; and generate a first checkpoint object representing the first state of the first process at the first time in Block S144.

Block S150 of the method S100 recites triggering a second checkpoint program executing at the second node to: access the first checkpoint object in Block S152; and restore the first state of the first process at a second set of resources in the second node by loading the first set of data into a second memory in the second node in Block S154.

The method S100 includes: terminating execution of the first process and the first checkpoint program at the first node in Block S146; and scheduling resumption of the first process at the second node based on the first set of data loaded into the second memory in Block S156.

Generally, in Blocks S130, S132, S140, S142, S144, S146, S150, S152, S154, and S156, the system can: monitor real-time performance characteristics of the population of nodes; calculate a new assignment of workloads—representing processes of jobs—to nodes in the population of nodes based on policies of the jobs and the real-time performance characteristics of the nodes; instantiate these workloads onto (and/or remove workloads from) nodes according to the new assignment; and schedule execution of the workloads at the nodes.

For example, the system can: monitor real-time performance characteristics of the population of nodes including a first node executing a first process of a job, such as a model training job; receive (or generate) an updated policy—defining an updated set of parameters for the job—during execution of the first process; identify a second node at which to schedule the first process based on the updated set of parameters and real-time performance characteristics associated with the first node and the second node; and serve a command (e.g., to a first checkpoint program executing at the first node) to checkpoint the first process.

In response to receiving the command to checkpoint the first process, the system can: capture a first state of the first process executing at the first node; generate a first checkpoint object representing the first state of the first process; transmit the first checkpoint object to the second node (e.g., to a second checkpoint program executing at the second node); restore (or load) the first state of the first process—stored in the first checkpoint object—at resource in the second node; and resume execution of the first process at the second node based on the first state restored at the resources in the second node. Additionally, the system can: terminate execution of the first process at the first node; and release the resources in the first node allocated to the first process.

Accordingly, the system can: change a policy for a model training job during execution of a process of the model training job at a first node; select a second node for execution of the process in response to changing the policy for the model training job; pause execution of the process at the first node; encapsulate a state of the process into a checkpoint object; transmit the checkpoint object to the second node; restore the state of the process into the resources of the second node; and resume execution from a point at which the process is paused.

Therefore, rather than waiting until completion of the model training job at the first node (or terminating the model training job at the first node and restarting execution of the model training job—from a beginning of the model training job—at the second node), the system can selectively pause and resume execution of processes of the model training job on different nodes based on time-varying performance of nodes and/or time-varying policies for the model training job, thereby optimizing deployment and execution (e.g., completion time) of the model training job within the cloud subsystem.

### 8.1 Workload Reassignment

Block S104 of the method S100 recites accessing a second policy for the job, the second policy defining a second set of parameters and a second objective function.

Block S132 of the method S100 recites selecting a second node in the population of nodes for the first process based on: the second set of parameters; a second subset of performance characteristics, in the second set of performance characteristics, for the second node; and the second objective function.

In one implementation, during a second time period succeeding the first time period, the cloud orchestrator executes the foregoing methods and techniques: to access a policy defining a set of parameters—such as including a target response time for the first job—and an objective function for the first job; and to access (or monitor) a set of performance characteristics associated with the population of nodes for a second time interval.

More specifically, for each node in the population of nodes, the cloud orchestrator can detect (or access) a subset of performance characteristics, in the set of performance characteristics, associated with the node for the second time interval.

For example, the cloud orchestrator can detect a first subset of performance characteristics—associated with the first node for the second time interval—including: a first central processing unit processing capacity of the first node; a first graphics processing unit processing capacity of the first node; a first network throughput of the first node; and a first locality of the first node.

In this example, the cloud orchestrator can detect a second subset of performance characteristic—-associated with the second node for the second time interval—including: a second central processing unit processing capacity of the second node; a second graphics processing unit processing capacity of the second node; a second network throughput of the second node; and a second locality of the second node.

In this implementation, the cloud orchestrator executes the foregoing methods and techniques to select the second node in the population of nodes for the first process based on: the set of parameters in the policy; the set of performance characteristics for the second time interval; and the objective function in the policy.

For example, in response to execution of a first segment of the first process at the first node, the cloud orchestrator can calculate a workload representing a remainder of the first job excluding the first segment of the first process. More specifically, the cloud orchestrator can: calculate a first workload representing the (entire) first job including the set of processes; calculate a second workload representing the first segment of the first process; and calculate a remaining workload—representing the remainder of the first job excluding the first segment of the first process—based on a difference between the first workload and the second workload.

In this example, for each node in the population of nodes, the cloud orchestrator can execute the foregoing methods and techniques: to access a subset of performance characteristics for the node; and to calculate an estimated response time—in the set of estimated response times—for the remainder of the first job at the node based on the subset of performance characteristics.

More specifically, the cloud orchestrator can calculate: a first estimated response time for the remainder of the first job based on the first subset of performance characteristics associated with the first node for the second time interval; and a second estimated response time for the remainder of the first job based on the second subset of performance characteristics associated with the second node for the second time interval.

In this example, the cloud orchestrator can select the second node for the first process in response to: the second estimated response time for the remainder of the first job at the second node exceeding a set of estimated response times for the remainder of the first job at nodes in the population of nodes (e.g., the first estimated response time for the remainder of the job at the first node); and the second estimated response time for the remainder of the first job at the second node exceeding the target response time for the first job.

Therefore, after deploying the first job to the first node, the cloud orchestrator can: monitor real-time performance characteristics of the population of nodes; calculate an earlier estimated response time for the first job at a second node relative to the first node; and reassign the first job (e.g., the remainder of the first job) from the first node to the second node.

In another implementation, in response to selecting the second node for the first process, the system (e.g., the cloud orchestrator, the checkpoint server) transmits a checkpoint command—to the first checkpoint program—to checkpoint the first process at the first node.

### 8.1.1 Workload Reassignment Plan

In one variation, in response to calculating a new assignment of workloads —representing processes of jobs—to nodes in the population of nodes, the cloud orchestrator: identifies a set of actions representing migration of a set of workloads from a first subset of nodes in the population of nodes to a second subset of nodes in the population of nodes; generates a notification specifying the set of actions; and serves the notification to the user via a user interface.

For example, in response to selecting the second node for the first process, the cloud orchestrator can identify the set of actions representing migration of the first process of the first job (e.g., a remainder of the first process of the first job) from the first node to the second node.

In this variation, the cloud orchestrator: receives confirmation of the set of actions from the user via the user interface; and transmits the checkpoint command—to the first checkpoint program—to checkpoint the first process at the first node in response to receiving confirmation of the set of actions by the user.

### 8.2 Process Checkpointing

Block S140 of the method S100 recites triggering a first checkpoint program executing at the first node to: record a first state of the first process executing at the first node in Block S142; and generate a first checkpoint object representing the first state of the first process at the first time in Block S144.

In another implementation, the first checkpoint program executes the foregoing methods and techniques: to receive the checkpoint command to checkpoint the first process; to record a first state of the first process executing at the first node; to generate a first checkpoint object representing the first state of the first process; and to transmit the first checkpoint object to the checkpoint server (or another data repository).

More specifically, the first checkpoint program can execute the foregoing methods and techniques to record the first state representing a first set of resources in the first node allocated to the first process at a first time.

For example, the first checkpoint program can execute the foregoing methods and techniques to record the first state representing: a first subset of data stored in a first set of processor registers in the first set of resources allocated to the first process; and a second subset of data stored in a first memory device (e.g., an L1 cache, an L2 shared memory) in the first set of resources allocated to the first process.

Additionally, the first checkpoint program can execute the foregoing methods and techniques to record the first state including a set of call records representing: a set of calls by the first process to an application programming interface of a graphics processing unit in the first node; and a set of memory operations, associated with the set of calls, for the graphics processing unit in the first node.

Therefore, the first checkpoint program can execute the foregoing methods and techniques to record the first state including a set of call records representing: a set of calls by the first process to an application programming interface(s) of a graphics processing unit(s) in the first node; and a set of memory operations, associated with the set of calls, for the graphics processing unit(s) in the first node.

Therefore, the system can: access the first checkpoint object representing the first state of the first process based on the set of call records; and execute (or “replay”) the set of calls represented in the set of call records in order to restore the first state at another graphics processing unit(s) in the second node.

### 8.4 Process Migration and Resumption

Block S150 of the method S100 recites triggering a second checkpoint program executing at the second node to: access the first checkpoint object in Block S152; and restore the first state of the first process at a second set of resources in the second node by loading the first set of data into a second memory in the second node in Block S154.

In one implementation, in response to selecting the second node at which to schedule the first process, the cloud orchestrator executes the foregoing methods and techniques: to instantiate (or execute) a second checkpoint program at the second node; to attach the second checkpoint program to the first process; and to allocate resources in the second node to the first process.

In this implementation, in Block S150, the cloud orchestrator triggers the second checkpoint program: to access the first checkpoint object from the checkpoint server (or another data repository) in Block S152; and to restore the first state of the first process—represented in the first checkpoint object—at the second node in Block S154.

More specifically, the second checkpoint program can: extract the set of data—recorded from memory of the first node at the first time—from the first checkpoint object; restore the set of data into memory (e.g., processor registers, memory address space) of the second node; restore the set of file descriptors associated with the first process at the second node; restore the set of file connections associated with the first process at the second node; and/or restore the set of network connections associated with the first process at the second node; etc.

In one example, the second checkpoint program: extracts the first subset of data—recorded from the first set of processor registers of the first node allocated to the first process at the first time—from the first checkpoint object; and loads the first set of data into a second set of processor registers in the second node.

In another example, the second checkpoint program: extracts the second subset of data—recorded from the first memory device of the first node allocated to the first process at the first time—from the first checkpoint object; and loads the second set of data into a second memory device (e.g., an L1 cache, an L2 shared memory) in the second node.

Additionally, the second checkpoint program executes methods and techniques described in U.S. patent application Ser. No. 18/957,400: to extract the set of call records from the first checkpoint object; to identify the set of calls and the set of memory operations based on the set of call records; to execute the set of calls to a second application programming interface(s) of a second graphics processing unit(s) in the second node; and to execute the set of memory operations in association with the second graphics processing unit(s).

In this implementation the cloud orchestrator schedules execution of the first process at the second node in Block S156.

For example, the second node can resume execution of the first process—based on the first set of data loaded into the second set of processor registers and the second set of data loaded into the second memory device in the second node—in response to: execution of the set of calls to the second application programming interface of the second graphics processing unit; and execution of the set of memory operations associated with the second graphics processing unit.

### 8.4.1 Workload Expansion

In one example, the cloud orchestrator receives an inference job and a policy, associated with the inference job, defining an objective function and a set of parameters including a target graphics processing unit utilization (e.g., a graphics processing unit utilization threshold, 90%). Additionally, the cloud orchestrator accesses a first expected quantity of inference requests for a second time interval (e.g., 500 requests per minute).

In this example, the cloud orchestrator: accesses a first set of performance characteristics representing a population of nodes for a first time interval preceding the second time interval; and selects a first node—in the population of nodes and at which to schedule the first process—based on the set of parameters, the first expected quantity of inference requests, a first subset of performance characteristics (e.g., presence of four graphics processing units in the first node) associated with the first node, and the objective function. The cloud orchestrator: instantiates the first checkpoint program and the first process on the first node; attaches the first checkpoint program to the first process; and schedules execution of the first process at the first node.

In this example, the cloud orchestrator accesses a set of execution characteristics representing resources in the first node allocated to the first process during execution of the first process at the first node. The set of execution characteristics represent a first graphics processing unit utilization (e.g., 95%).

In response to detecting the first graphics processing unit utilization exceeding the target graphics processing unit utilization, the cloud orchestrator: accesses a second set of performance characteristics representing the population of nodes for the second time interval; accesses a second expected quantity of inference requests for a third time interval (e.g., 1,000 requests per minute); and selects a second node and a third node, in the population of nodes, for the first process.

More specifically, the cloud orchestrator can select the second node and the third node for the first process based on: the set of parameters; the second expected quantity of inference requests; a second subset of performance characteristics (e.g., presence of eight graphics processing units in the second node), in the second set of performance characteristics, associated with the second node; a third subset of performance characteristics (e.g., presence of eight graphics processing units in the third node), in the second set of performance characteristics, associated with the third node; and the objective function.

In this example, the cloud orchestrator triggers the first checkpoint program executing at the first node: to record a first state of the first process executing at the first node; to generate a first checkpoint object representing the first state of the first process; and to transmit the first checkpoint object to the checkpoint server.

More specifically, the first checkpoint program can record the first state including a set of data—representing a model (e.g., a large language model) and a set of weights for the model—stored in memory of the first node.

In response to instantiating a second checkpoint program and the first process on the second node, the cloud orchestrator triggers the second checkpoint program: to access the first checkpoint object from the checkpoint server; and to restore the first state of the first process, represented in the first checkpoint object, at the second node by loading the set of data—including the model and the set of weights for the model —into memory at the second node.

In response to instantiating a third checkpoint program and the first process on the third node, the cloud orchestrator repeats the foregoing methods and techniques to trigger the third checkpoint program: to access the first checkpoint object from the checkpoint server; and to restore the first state of the first process, represented in the first checkpoint object, at the third node by loading the set of data—including the model and the set of weights for the model—into memory at the third node.

In this example, the cloud orchestrator: terminates execution of the first process at the first node; and schedules resumption of the first process at the second node and the third node based on the set of data—including the model and the set of weights for the model—loaded into memories at the second node and the third node.

Accordingly, the system can: access execution characteristics representing a graphics processing unit utilization by the first process of the inference job executing at the first node; detect the graphics processing unit utilization exceeding a graphics processing unit utilization threshold defined by the policy associated with the inference job; detect an increase in an expected quantity of inference requests; and migrate the first process of the inference job to the second node and the third node—each including greater graphics processing unit capacity relative to the first node—in order to load balance the inference requests of the inference job between the second node and the third node, reduce a response time of the inference job executing at the second node and the third node, and/or reduce occurrence of failed execution of the inference job (e.g., memory overflow, processor fault) at the second node and the third node.

More specifically, the system can: initialize and/or configure the model associated with the first process at the first node; encapsulate the first state of the first process—after initialization and/or configuration of the model-into the first checkpoint object for restoration at the second node and the third node; and restore the first state of the first process in resources of the second node and the third node.

Therefore, by restoring the first state of the first process—recorded after initialization and/or configuration of the model at the first node—at the second node and the third node, the system can bypass initialization and/or configuration of the model (e.g., loading weights into memory from disk storage) at the second node and the third node, thereby reducing a “time to first token” (and/or a “cold start time”) associated with the inference job.

### 8.4.2 Node Consolidation

In another example, the cloud orchestrator receives a first job (e.g., a first inference job) and a second job (e.g., a second inference job).

The cloud orchestrator receives a first policy associated with the first job. The first policy defines a first set of parameters (e.g., a first minimum processor capacity) and a first objective function.

The cloud orchestrator also receives a second policy associated with the second job. The second policy defines a second set of parameters (e.g., a second minimum processor capacity) and a second objective function.

In this example, the cloud orchestrator: accesses a first set of performance characteristics representing a population of nodes for a first time interval; and selects a first node—in the population of nodes and at which to schedule a first process of the first job—based on the first set of parameters, a first subset of performance characteristics associated with the first node, and the first objective function.

The cloud orchestrator executes methods and techniques described in U.S. patent application No. 18/957,400: to instantiate a first container at the first node; to instantiate a first checkpoint program at the first node; to allocate resources in the first node to the first container and/or the first process; and to schedule execution of the first process within the first container at the first node.

Additionally, the cloud orchestrator: selects a second node—in the population of nodes and at which to schedule a second process of the second job—based on the second set of parameters, a second subset of performance characteristics associated with the second node, and the second objective function; instantiates a second container at the second node; instantiates a second checkpoint program at the second node; allocates resources in the second node to the second container and/or the second process; and schedules execution of the second process within the second container at the first node.

The cloud orchestrator accesses a second set of performance characteristics representing the population of nodes for the second time interval. The second set of performance characteristics includes: a third subset of performance characteristics, associated with the first node, representing a first processor utilization (e.g., 10%) attributed to the first process executing within the first container; and a fourth subset of performance characteristics, associated with the second node, representing a second processor utilization (e.g., 12%) attributed to the second process executing within the second container.

In this example, the cloud orchestrator selects the second node for the first process and the second process based on: the first policy; the second policy; and the second set of performance characteristics. More specifically, the cloud orchestrator can: calculate a combination (e.g., a sum) of the first processor utilization and the second processor utilization; and select the second node for the first process and the second process in response to the combination of the first processor utilization and the second processor utilization falling below the first minimum processor capacity and the second minimum processor capacity.

The cloud orchestrator triggers the first checkpoint program executing at the first node: to record a first state of the first process executing within the first container; and to generate a first checkpoint object representing the first state of the first process.

The cloud orchestrator: instantiates a third container at the second node; instantiates a third checkpoint program at the second node; allocates resources in the second node to the third container and/or the first process; triggers the third checkpoint program to restore the first state of the first process, represented in the first checkpoint object, at the second node; schedules resumption of the first process within the third container at the second node; and schedules execution of the second process within the second container at the second node.

Accordingly, the system can: deploy workloads—representing processes of jobs—onto a group of nodes; access performance characteristics representing resource utilization of the nodes during execution of the workloads; and detect under-utilization of resources in these nodes based on the performance characteristics. The system can then: record states of the workloads; consolidate the workloads by migrating these states to a subgroup of nodes in the group of nodes; and release resources of nodes excluded from the subgroup of nodes, thereby increasing efficiency and reducing resource costs during execution of these workloads.

### 8.4.3 Preemptible Nodes

In another example, the cloud orchestrator receives: a model training job including a first process; and a policy defining a set of parameters for the model training job and an objective function.

In this example, the cloud orchestrator: accesses a first set of performance characteristics representing a population of nodes for a first time interval preceding the second time interval; and selects a first preemptible node (or a “spot” node)—in the population of nodes and at which to schedule the first process-based on the set of parameters, a first subset of performance characteristics associated with the first preemptible node, and the objective function. The first preemptible node is associated with a first remote contract computing network.

The cloud orchestrator: instantiates a first checkpoint program and the first process on the first preemptible node; attaches the first checkpoint program to the first process; and schedules execution of the first process of the model training job at the first preemptible node.

In response to detecting preemption of the first process at the first preemptible node by the first remote contract computing network, the cloud orchestrator triggers the first checkpoint program: to record the first state of the first process executing at the first preemptible node, the first state representing the first set of resources in the first preemptible node allocated to the first process of the model training job; to generate a first checkpoint object representing the first state of the first process; and to transmit the first checkpoint object to the checkpoint server.

In this example, the cloud orchestrator: accesses a second set of performance characteristics representing the population of nodes for a second time interval; and selects a second preemptible node, in the population of nodes, for the first process based on the set of parameters, a second subset of performance characteristics associated with the second preemptible node, and the objective function. The second preemptible node can be associated with a second remote contract computing network different from the first remote contract computing network.

The cloud orchestrator: instantiates a second checkpoint program and the first process on the second preemptible node; and attaches the second checkpoint program to the first process. The cloud orchestrator triggers the second checkpoint program: to access the first checkpoint object from the checkpoint server; and to restore the first state of the first process of the model training job at resources in the second preemptible node. The cloud orchestrator schedules execution of the second process of the model training job at the second preemptible node based on the first state of the first process.

Accordingly, the system can: deploy the model-building job on a first preemptible node associated with a first remote contract computing network; execute the model training job at the first preemptible node; checkpoint—in real-time (or near-real-time) —a state of the model training job at the first preemptible node in response to preemption of the model training job by the first remote contract computing network; and store the state of the model training job for later resumption at another node, such as a second preemptible node associated with a second remote contract computing network.

Therefore, the system can extend fine-grained (e.g., near-real-time) suspension, checkpointing, and resumption functionality to the model training job without modification thereto, thereby enabling deployment of the model training job to preemptible nodes—characterized by decreased costs relative to nominal (or non-preemptible) nodes in the population of nodes—in order to reduce a total cost for model training.

### 8.4.4 Response Time and Locality

In another example, the cloud orchestrator receives an inference job and a policy, associated with the inference job, defining a set of parameters including: a first parameter representing a maximum response time (e.g., one minute); and a second parameter representing locality (e.g., location of a node based on local time). More specifically, the cloud orchestrator can receive the policy defining the second parameter specifying a region exhibiting a local time between 7:00 A.M. and 7:00 P. M (or a “peak period”).

In this example, the cloud orchestrator: accesses a first set of performance characteristics associated with the population of nodes for a first time interval; and selects a first node—in the population of nodes and at which to schedule a first process of the inference job during the first time interval—based on the set of parameters and a first subset of performance characteristics (e.g., a response time of 45 seconds, a local time of 6:00 P.M.) associated with the first node. The cloud orchestrator: instantiates the first process and a checkpoint program on the first node; attaches the checkpoint program to the first process; and schedules execution of the first process at the first node.

Then, the cloud orchestrator accesses a second set of performance characteristics associated with the population of nodes during a second time interval succeeding the first time interval. In response to detecting a deviation between a second subset of performance characteristics (e.g., a local time of 7:01 P. M)—associated with the first node during the second time interval- and the set of parameters, the system executes the foregoing methods and techniques: to record a first state of the first process executing on the first node; to terminate execution of the first process at the first node; and to release resources of the first node allocated to the first process.

In this example, the cloud orchestrator identifies a second node, in the population of nodes and at which to schedule the first process during the second time interval, based on the set of parameters and a third subset of performance characteristics (e.g., a response time of 30 seconds, a local time of 9:01 A. M) associated with the second node for the second time interval.

In response to identifying the second node, the system executes the foregoing methods and techniques: to restore the first state of the first process at resources in the second node; to schedule execution of the first process at the second node; and to resume execution of the first process based on the first state.

Accordingly, the system can: pause execution of the inference job on the first node exhibiting a first local time falling outside of the peak period; migrate the inference job to the second node exhibiting a second local time falling within the peak period; and resume execution of the inference job—on the second node—from a point at which the inference job is paused. Therefore, the system can migrate the inference job globally alongside a local userbase during the peak period, thereby minimizing a response time and/or latency of the inference job experienced by a user during the peak period.

### 8.4.5 Multiple Jobs According to Multiple Policies

In another example, the cloud orchestrator receives a model training job and an inference job.

The cloud orchestrator receives a first policy—associated with the model training job and prioritizing total cost minimization—defining: a first parameter representing a maximum total cost of the model training job (e.g., 30 million dollars); and a second parameter representing a first maximum response time (or completion time) of the model training job (e.g., one month). Additionally, the cloud orchestrator receives a second policy—associated with the inference job and prioritizing reliability maximization —defining: a third parameter representing a minimum reliability of the inference job (e.g., 98% reliability); and a fourth parameter representing a second maximum response time of the inference job (e.g., one minute).

During a first time period (e.g., 12:00 A.M. to 8:00 A.M.), the cloud orchestrator accesses a first set of performance characteristics associated with a set of nodes (e.g., 10,000 nodes) for a first time interval. Based on the first set of performance characteristics (e.g., two dollars per graphics processing unit per hour), a first expected demand of the inference job during the first time period (e.g., 10,000 requests per minute), and the first and second policies, the cloud orchestrator: selects a first subset of nodes (e.g., 9,000 nodes) in the set of nodes and at which to schedule instances of the model training job during the first time interval; and selects a second subset of nodes (e.g., 1,000 nodes) in the set of nodes and at which to schedule instances of the inference job during the first time interval.

The cloud orchestrator executes the foregoing methods and techniques: to instantiate instances of the model training job and the checkpoint program onto the first subset of nodes; to instantiate checkpoint programs and instances of the inference job onto the second subset of nodes; and to schedule execution of these instances of the model training job and the inference job at the first and second subsets of nodes.

During a second time period (e.g., 8:00 A.M. to 8:00 P.M.) succeeding the first time period, the cloud orchestrator accesses a second set of performance characteristics associated with the set of nodes for a second time interval. Based on the second set of performance characteristics (e.g., five dollars per graphics processing unit per hour), a second expected demand of the inference job during the first time period (e.g., 50,000 requests per minute), and the first and second policies, the cloud orchestrator selects the first subset of nodes to schedule additional instances of the inference job during the second time interval.

The cloud orchestrator executes the foregoing methods and techniques: to record states of the model training job executing on the first subset of nodes; to store these states within the checkpoint server; to remove the model training job from the first subset of nodes; to instantiate checkpoint programs and instances of the inference job onto the first subset of nodes; and to schedule execution of these instances of the inference job at the first subset of nodes.

During a third time period (e.g., 8:00 P.m. to 12:00 P.m.) succeeding the second time period, the cloud orchestrator accesses a third set of performance characteristics associated with the set of nodes for a third time interval. Based on the third set of performance characteristics (e.g., three dollars per graphics processing unit per hour), a third expected demand of the inference job during the first time period (e.g., 20,000 requests per minute), and the first and second policies, the cloud orchestrator selects a third subset of nodes (e.g., 5,000 nodes), in the set of nodes, to schedule instances of the model training job during the third time interval.

The cloud orchestrator executes the foregoing methods and techniques: to restore the states of the model training job on the third subset of nodes; to schedule execution of the model training job at the third subset of nodes node; and to resume execution of the model training job.

Accordingly, the system can: schedule execution of the model training job during the first time period while expected demand for the inference job and cost per graphics processing unit are relatively low; and pause execution of the model training job —in order to execute additional instances of the inference job-during the second time period while expected demand for the inference job and cost per graphics processing unit are increased. Then, during the third time period while expected demand for the inference job and cost per graphics processing unit are decreased, the system can: remove instances of the inference job from a subset of nodes; and resume execution of the inference job—on this subset of nodes—from a point at which the model training job is paused. Therefore, the system can the optimize deployment and execution of the model training and inference jobs across the set of nodes at different times based on fluctuations in performance, cost, and/or expected demand, thereby minimizing a total cost of the model training job and maximizing reliability of the inference job in accordance with the first and second policies.

### 8.5 Process Preemption

In one variation, during a second time period succeeding the first time period, the cloud orchestrator executes the foregoing methods and techniques: to access a policy defining a target configuration representing a set of parameters—such as a maximum cost per graphics processing unit per hour (e.g., three dollars per graphics processing unit per hour)—and an objective function for the first job; and to access a set of performance characteristics associated with the population of nodes for a second time interval.

More specifically, for each node in the population of nodes, the cloud orchestrator can detect (or access) a subset of performance characteristics, in the set of performance characteristics and representing a cost per graphics processing unit per hour, associated with the node for the second time interval.

For example, the cloud orchestrator can detect a first subset of performance characteristics, in the set of performance characteristics, associated with the first node for the second time interval. The first subset of performance characteristics can represent a first cost per graphics processing unit per hour (e.g., five dollars per graphics processing unit per hour) for the first node.

In this variation, in response to absence of a node exhibiting a subset of performance characteristics corresponding to (or falling within) a target configuration representing the set of parameters, the cloud orchestrator calculates a new assignment of workloads—excluding the first process—to nodes in the population of nodes.

For example, in response to absence of a node exhibiting a cost per graphics processing unit per hour falling below the maximum cost per graphics processing unit per hour defined by the policy, the cloud orchestrator can preempt the first process for the second time period.

### 10. Policy Changes

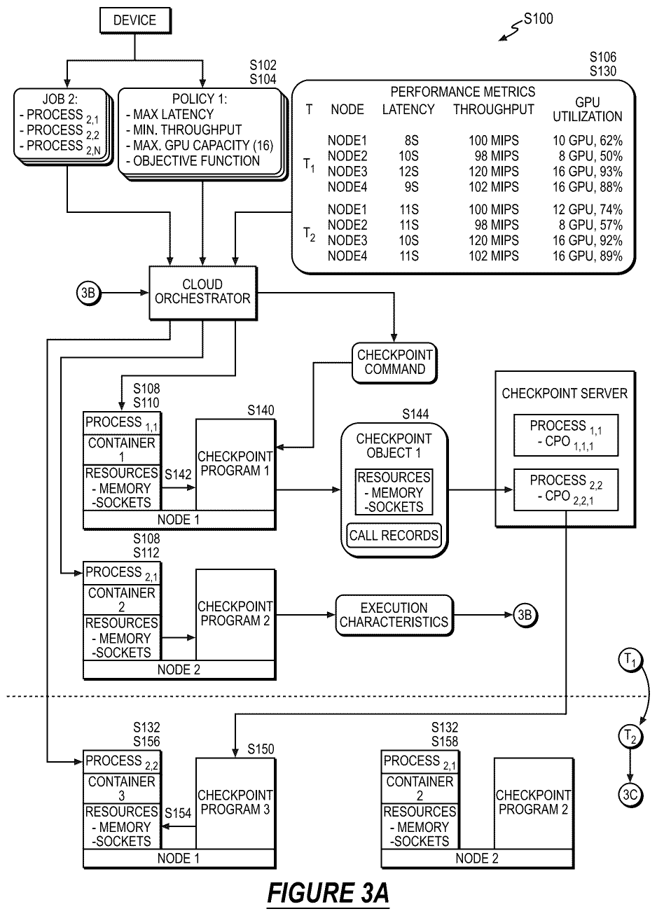

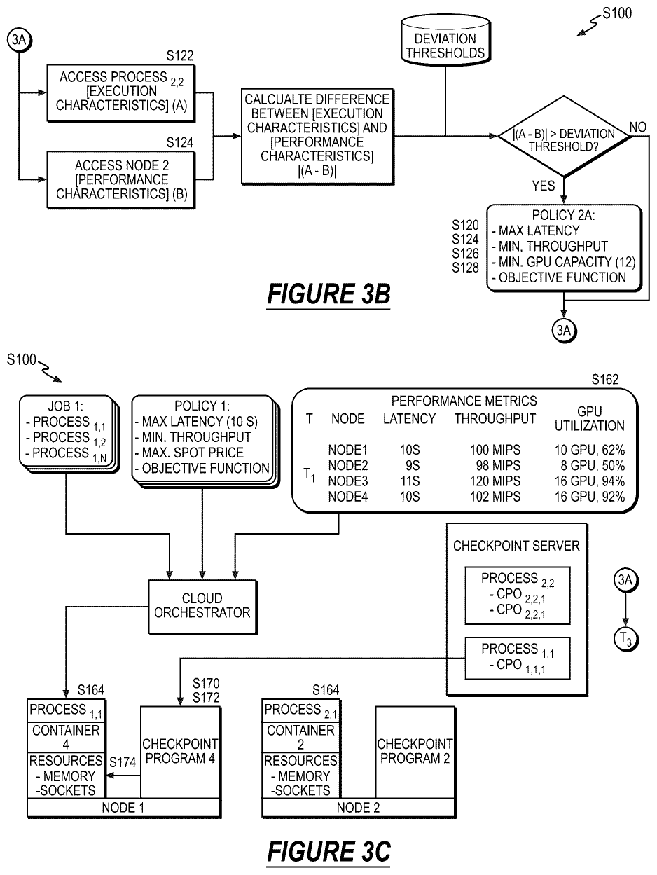

In one implementation, as shown in FIGS. 3A, 3B, and 3C, the cloud orchestrator executes the foregoing methods and techniques: to access a policy for a job including a first process, the policy defining a first set of parameters and a first objective function; to access a first set of performance characteristics representing a population of nodes for a first time interval; to select a first node, in the population of nodes, for a first process of a job based on the policy for the job and a first subset of performance characteristics—in the first set of performance characteristics—for the first node; and to schedule execution of the first process at the first node.

In another implementation, the cloud orchestrator detects a change in the policy for the job during execution of the job at the first node and prior to completion of the job.

More specifically, the cloud orchestrator can detect: a change from the first set of parameters to a second set of parameters—different from the first set of parameters —for the job; and/or a change from the first objective function to a second objective function, different from the first objective function, for the job. Alternatively, the cloud orchestrator can detect a change from the first policy—defining the first set of parameters and the first objective function—to a second policy, defining the second set of parameters and the second objective function, assigned to the job.

In response to detecting the change in the policy, the cloud orchestrator executes the foregoing methods and techniques: to access a second set of performance characteristics representing the population of nodes for a second time interval; and to select a second node, in the population of nodes, for the first process based on the policy and performance characteristics—in the second set of performance characteristics—for the second node.

In this implementation, the cloud orchestrator executes the foregoing methods and techniques: to trigger the first node to record a first state of the first process and generate a checkpoint object representing the first state; to trigger the second node to access the checkpoint object and restore the first state at the second node; and to schedule resumption of the first process at the second node based on the first state of the first process.

For example, the cloud orchestrator can: receive a first policy defining a first set of parameters—including a first target completion time—for a model training job including a first process; and access a first set of performance characteristics representing a population of nodes for a first time interval. The cloud orchestrator can select a first node, in the population of nodes, for the first process based on: the first set of parameters; and a first subset of performance characteristics, in the first set of performance characteristics, for the first node. The cloud orchestrator can schedule execution of the first process at the first node.

In this example, the cloud orchestrator can detect a change from the first set of parameters to a second set of parameters—different from the first set of parameters —for the model training job.

More specifically, the cloud orchestrator can receive a second policy for the model training job from a user, the second policy defining a second set of parameters different from the first set of parameters. The second set of parameters can include a second target completion time falling below the first target completion time. Additionally or alternatively, the second policy can define a second target configuration representing the second set of parameters corresponding to a second set of target performance characteristics.

In response to detecting a change from the first policy to the second policy for the model training job (e.g., a change from the first set of parameters to the second set of parameters) prior to completion of the model training job at the first node, the cloud orchestrator can: access a second set of performance characteristics representing the population of nodes for a second time interval; and select a second node, in the population of nodes, for the first process based on the second policy (e.g., based on the second set of parameters including the second target completion time) and a second subset of performance characteristics—in the second set of performance characteristics—for the second node. The cloud orchestrator can select the second node in response to the second subset of performance characteristics corresponding to (or falling within) the second target configuration.

In this example, the cloud orchestrator: triggers a first checkpoint program at the first node to record a first state of the first process and generate a checkpoint object representing the first state; triggers a second checkpoint program at the second node to access the checkpoint object and restore the first state at the second node; and schedules resumption of the first process at the second node based on the first state of the first process.

Accordingly, the system can: enable the user to change a policy for the model training job in real-time during execution of the model training job at a first node; automatically select a second node at which to schedule and execute the model training job based on the policy; and pause, migrate, and resume execution of the model training job—at the second node—from a point at which the model training job is paused.

Therefore, rather than waiting until completion of the model training job at the first node (or terminating the model training job at the first node and restarting execution of the model training job—from a beginning of the model training job—at the second node), the system can selectively pause and resume execution of processes of the model training job on different nodes based on time-varying performance of nodes and/or time-varying policies for the model training job, thereby optimizing deployment and execution (e.g., completion time) of the model training job within the cloud subsystem.

### 10.1 Policy Recommendations

In another implementation, the cloud orchestrator executes the foregoing methods and techniques: to access a first policy for a job including a first process; to access a first set of performance characteristics representing a population of nodes for a first time interval; to select a first node, in the population of nodes, for a first process of a job based on the first policy for the job and a first subset of performance characteristics—in the first set of performance characteristics-for the first node; and to schedule execution of the first process at the first node. The first policy can define a first set of parameters—such as a first target graphics processing unit capacity of sixteen graphics processing units—and a first objective function.

In this implementation, the cloud orchestrator: accesses a set of execution characteristics representing resources allocated to the first process during execution of the first process at the first node in Block S122; detects a deviation between the set of execution characteristics and the first set of parameters in Block S124; generates a second set of parameters based on the deviation in Block S126; generates a second policy (e.g., a recommended policy) for the job and defining the second set of parameters in Block S128; and serves the second policy to a user.

For example, the cloud orchestrator can: access the set of execution characteristics representing a first graphics processing unit utilization indicating eight idle graphics processing units allocated to the first process during execution; and calculate a difference between the first graphics processing unit utilization and the first target graphics processing unit capacity. In response to detecting the difference between the first graphics processing unit utilization and the first target graphics processing unit capacity exceeding a threshold amount (e.g., 20%, 50%), the cloud orchestrator can: generate a second set of parameters including a second target graphics processing unit capacity of twelve graphics processing units; and generate the second policy defining the second set of parameters. Additionally or alternatively, the second policy can define a second target configuration representing the second set of parameters corresponding to a second set of target performance characteristics.

In response to detecting a change from the first policy to the second policy for the model training job (e.g., a change from the first set of parameters to the second set of parameters) prior to completion of the model training job at the first node, the cloud orchestrator can: access a second set of performance characteristics representing the population of nodes for a second time interval; and select a second node, in the population of nodes, for the first process based on the second policy (e.g., based on the second set of parameters including the second target completion time) and a second subset of performance characteristics—in the second set of performance characteristics—for the second node. The cloud orchestrator can select the second node in response to the second subset of performance characteristics corresponding to (or falling within) the second target configuration.

In this example, the cloud orchestrator can: generate a notification specifying the second policy including the second target graphics processing unit capacity; and serve the notification to the user.

In this implementation, in response to confirmation of the second policy (e.g., the second target graphics processing unit capacity) by the user, the cloud orchestrator executes the foregoing methods and techniques: to access a second set of performance characteristics representing the population of nodes for a second time interval; and to select a second node, in the population of nodes, for the first process based on the second policy and performance characteristics—in the second set of performance characteristics—for the second node. The cloud orchestrator can select the second node in response to the second subset of performance characteristics corresponding to (or falling within) the second target configuration.

The cloud orchestrator then executes the foregoing methods and techniques: to trigger the first node to record a first state of the first process and generate a checkpoint object representing the first state; to trigger the second node to access the checkpoint object and restore the first state at the second node; and to schedule resumption of the first process at the second node based on the first state of the first process.

Accordingly, the system can: select a first node for execution of a first process of a job based on a first policy for the job; detect an under-utilization of node resources (e.g., graphics processing units)—relative to a target resource capacity defined by the first policy—during execution of the first process at the first node; and generate a second policy that defines a reduced target resource capacity in order to adjust (or “right-size”) parameters according to execution characteristics of the first process at the first node.

Therefore, the system can: analyze execution of a job on a node selected according to a policy and/or a set of parameters; and recommend (e.g., in real-time or near-real-time) modifications to the policy and/or the set of parameters, thereby enabling the system to better optimize deployment and execution of the job across the population of nodes.

### 10.2 Multiple Jobs With Multiple Policies

In one example, the cloud orchestrator receives an inference job and a model training job.

In Block S102, the cloud orchestrator receives a first policy associated with the inference job. The first policy defines a first set of parameters and a first objective function that prioritizes response time minimization. The first set of parameters includes a maximum response time of the inference job (e.g., one minute).

In Block S104, the cloud orchestrator receives a second policy associated with the model training job. The second policy defines a second set of parameters and a second objective function that prioritizes completion time minimization. The second set of parameters includes a first minimum graphics processing unit capacity (e.g., sixteen graphics processing units).

During a first time period (e.g., 8:00 A.M. to 8:00 P.M.), the cloud orchestrator: accesses a first set of performance characteristics associated with a set of nodes for a first time interval in Block S106; and calculates a first assignment of workloads to nodes in the set of nodes based on the first set of parameters, the second set of parameters, and the first set of performance characteristics in Block S108.

More specifically, the cloud orchestrator can select a first node in the set of nodes for a first process of the inference job based on performance characteristics (e.g., presence of twelve graphics processing units) of the first node for the first time interval, a first expected demand of the inference job during the first time period (e.g., 1,000 requests per minute), the first policy, and/or the second policy.

Additionally, the cloud orchestrator can select a second node in the set of nodes for a second process of the second job based on performance characteristics (e.g., presence of sixteen graphics processing units) of the second node for the first time interval, the first policy, and/or the second policy.

The cloud orchestrator: schedules execution of the first process at the first node in Block S110; and schedules execution of the second process at the second node in Block S112.

During a second time period (e.g., 12:00 A.M. to 8:00 A.M.) succeeding the first time period, the cloud orchestrator: accesses a set of execution characteristics—including a graphics processing unit utilization (e.g., twelve graphics processing units)—representing resources allocated to the second process during execution of the second process at the second node; detects a deviation between the set of execution characteristics and the second set of parameters; generates a third set of parameters based on the deviation in Block S140; and generates a third policy for the model training job and defining the third set of parameters in Block S128.

More specifically, the cloud orchestrator can: access the set of execution characteristics representing the graphics processing unit utilization indicating four idle graphics processing units allocated to the second process during execution in Block S122; and calculate a difference between the graphics processing unit utilization and the first minimum graphics processing unit capacity. In response to detecting the difference between the graphics processing unit utilization and the first minimum graphics processing unit capacity exceeding a threshold amount (e.g., 20%), the cloud orchestrator can: generate the third set of parameters including a second minimum graphics processing unit capacity of twelve graphics processing units in Block S126; and generate the third policy defining the third set of parameters in Block S128.

In response to generating the third policy for the model training job, the cloud orchestrator: accesses a second set of performance characteristics associated with the set of nodes for a second time interval in Block S130; and calculates a second assignment of workloads to nodes in the set of nodes based on the first set of parameters, the third set of parameters, and the second set of performance characteristics in Block S132.

More specifically, the cloud orchestrator can select the second node for the second process of the model training job—and the first node for a third process of the model training job—based on performance characteristics (e.g., presence of twelve graphics processing units) of the first node for the second time interval, a second expected demand of the inference job during the second time period (e.g., 500 requests per minute), the first policy, and/or the third policy.

In this example, in Block S140, the cloud orchestrator triggers a first checkpoint program in the first node: to record a first state of the first process in Block S142; to generate a first checkpoint object representing the first state in Block S144; and to transmit the first checkpoint object to the checkpoint server.

Additionally, in Block S150, the cloud orchestrator triggers a second checkpoint program in the second node: to access a second checkpoint object representing a second state of the third process of the model training job in Block S152; and to restore the second state of the third process onto resources at the second node in Block S154.

The cloud orchestrator: terminates execution of the first process and the first checkpoint program at the first node in Block S146; and schedules resumption of the third process at the first node based on the second state of the third process in Block S156.

During a third time period (e.g., 8:00 A.M. to 8:00 P.M.) succeeding the second time period, the cloud orchestrator: accesses a third set of performance characteristics associated with the set of nodes for a third time interval in Block S162; and calculates a third assignment of workloads to nodes in the set of nodes based on the first set of parameters, the third set of parameters, and the second set of performance characteristics in Block S164.

More specifically, the cloud orchestrator can select the second node for the second process of the model training job—and the first node for the first process of the inference job—based on performance characteristics (e.g., presence of twelve graphics processing units) of the first node for the second time interval, a second expected demand of the inference job during the second time period (e.g., 1,200 requests per minute), the first policy, and/or the third policy.

In this example, the cloud orchestrator triggers a third checkpoint program in the first node: to record a third state of the third process; to generate a third checkpoint object representing the third state; and to transmit the third checkpoint object to the checkpoint server.

Additionally, in Block S170, the cloud orchestrator triggers a fourth checkpoint program in the second node: to access the first checkpoint object representing the first state of the first process of the inference job in Block S172; and to restore the first state of the first process onto resources at the first node in Block S174.

The cloud orchestrator: terminates execution of the third process at the first node; and schedules resumption of the first process at the first node based on the first state of the first process.

Accordingly, the system can: detect under-utilization of graphics processing units-relative to a minimum graphics processing unit capacity defined by an initial policy for the model training job-during execution of the model training job at the second node; decrease the minimum graphics processing unit capacity in an updated policy for the model training job; and pause execution of the inference job at the first node during the second time period while expected demand for the inference job is relatively low.

Therefore, by decreasing the minimum graphics processing unit capacity in an updated policy for the model training job, the system can schedule an additional instance of the model training job at the first node-previously excluded from selection for the model training job due to insufficient graphics processing unit capacity according to the initial policy-in accordance with the updated policy in order to accelerate completion time of model training.

Then, during the third time period, while expected demand for the inference job is increased, the system can: remove the instance of the model training job from the first node; and resume execution of the inference job at the first node from a point at which the inference job is paused. Therefore, the system can optimize deployment and execution of the model training and inference jobs across the set of nodes at different times based on fluctuations in performance, cost, and/or expected demand.

### 11. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period:
accessing a first policy for a job comprising a first process, the first policy defining a first set of parameters and a first objective function;
accessing a first set of performance characteristics representing a population of nodes for a first time interval;
selecting a first node, in the population of nodes, for the first process based on:
the first set of parameters;
a first subset of performance characteristics, in the first set of performance characteristics, for the first node; and
the first objective function; and
scheduling execution of the first process at the first node; and
during a second time period succeeding the first time period:
accessing a second policy for the job, the second policy defining a second set of parameters and a second objective function;
accessing a second set of performance characteristics representing the population of nodes for a second time interval;
selecting a second node, in the population of nodes, for the first process based on:
the second set of parameters;
a second subset of performance characteristics, in the second set of performance characteristics, for the second node; and
the second objective function;
triggering a first checkpoint program executing at the first node to:
record a first state of the first process executing at the first node, the first state:
representing a first set of resources in the first node allocated to the first process at a first time; and
comprising a first set of data stored in a first memory in the first set of resources; and
generate a first checkpoint object representing the first state of the first process at the first time;
terminating execution of the first process and the first checkpoint program at the first node;
triggering a second checkpoint program executing at the second node to:
access the first checkpoint object; and
restore the first state of the first process at a second set of resources in the second node by loading the first set of data into a second memory in the second node; and
scheduling resumption of the first process at the second node based on the first set of data loaded into the second memory.

2. The method of claim 1:
wherein triggering the first checkpoint program to record the first state of the first process comprises triggering the first checkpoint programing to record the first state comprising a first set of call records representing:
a set of calls to a first application programming interface of a first graphics processing unit in the first node; and
a set of memory operations, associated with the set of calls, for the first graphics processing unit;
wherein triggering the second checkpoint program to restore the first state of the first process comprises triggering the second checkpoint program to:
extract the set of call records from the first checkpoint object;
identify the set of calls and the set of memory operations based on the set of call records;
execute the set of calls to a second application programming interface of a second graphics processing unit in the second node; and
execute the set of memory operations, associated with the set of calls, for the second graphics processing unit; and
wherein scheduling resumption of the first process at the second node comprises scheduling resumption of the first process at the second node based on the first set of data loaded into the second memory in response to:
execution of the set of calls to the second application programming interface of the second graphics processing unit; and
execution of the set of memory operations for the second graphics processing unit.

3. The method of claim 2, wherein scheduling execution of the first process at the first node comprises triggering the first checkpoint program to:
intercept a first call in the set of calls to the first application programming interface of the first graphics processing unit in the first node;
detect a first subset of memory operations, in the set of memory operations, associated with the first call and the first graphics processing unit; and
generate a first call record, in the set of call records, representing the first call and the first subset of memory operations.

4. The method of claim 1:
wherein accessing the second policy comprises accessing the second policy defining the second set of parameters comprising a target response time for the job;
wherein accessing the second set of performance characteristics comprises accessing the second subset of performance characteristics representing:
a central processing unit processing capacity of the second node;
a graphics processing unit processing capacity of the second node;
a network throughput of the second node; and
a locality of the second node; and
wherein selecting the second node comprises:
in response to execution of a first segment of the first process at the first node, calculating a workload representing a remainder of the job excluding the first segment of the first process;
calculating a first estimated response time, in a set of estimated response times, for the job at the second node based on the first subset of performance characteristics and the workload; and
selecting the second node for the first process in response to:
the first estimated response time for the workload at the second node falling below estimated response times, in the set of estimated response times, for the workload at nodes in the population of nodes; and
the first estimated response time for the workload at the second node exceeding the target response time for the job.

5. The method of claim 1:
wherein accessing the first policy comprises accessing the first policy defining the first set of parameters comprising a first target graphics processing unit capacity for the job;
wherein accessing the second policy comprises:
accessing a set of execution characteristics representing resources allocated to the first process during execution of the first process at the first node, the set of execution characteristics representing a first graphics processing unit utilization;
calculating a difference between the first graphics processing unit utilization and the first target graphics processing unit capacity; and
in response to the difference between the first graphics processing unit utilization and the first target graphics processing unit capacity exceeding a threshold amount, generating the second policy for the job, the second policy defining the second set of parameters comprising a second target graphics processing unit capacity falling below the first target graphics processing unit capacity; and
wherein selecting the second node comprises selecting the second node for the first process in response to generating the second policy.

6. The method of claim 5:
wherein generating the second policy comprises:
generating a notification specifying the second target graphics processing unit capacity; and
serving the notification to a user; and
wherein selecting the second node comprises selecting the second node for the first process in response to receiving confirmation of the second target graphics processing unit capacity by the user.

7. The method of claim 1:
wherein accessing the first policy comprises accessing the first policy defining the first set of parameters comprising a graphics processing unit utilization threshold;
wherein selecting the second node comprises:
accessing a set of execution characteristics representing resources in the first node allocated to the first process during execution of the first process at the first node, the set of execution characteristics representing a first graphics processing unit utilization; and
in response to the detecting first graphics processing unit utilization exceeding the graphics processing unit utilization threshold, selecting the second node and a third node, in the population of nodes, for the first process based on:
the second set of parameters;
the second subset of performance characteristics, in the second set of performance characteristics, for the second node;
a third subset of performance characteristics, in the second set of performance characteristics, for the third node; and
the second objective function;
further comprising triggering a third checkpoint program executing at the third node to:
access the first checkpoint object; and
restore the first state of the first process at a third set of resources in the second node by loading the first set of data into a third memory in the third node; and
wherein scheduling resumption of the first process comprises scheduling resumption of the first process at the second node and the third node based on:
the first set of data loaded into the second memory at the second node; and
the first set of data loaded into the third memory at the third node.

8. The method of claim 7:
wherein accessing the first policy for the job comprises accessing the first policy for the job comprising an inference job, the inference job comprising the first process;
wherein triggering the first checkpoint program to record the first state of the first process comprises triggering the first checkpoint program to record the first state of the first process of the inference job executing at the first node, the first state comprising the first set of data representing a model and a set of weights for the model;
wherein triggering the second checkpoint program to restore the first state of the first process comprises triggering the second checkpoint program to restore the first state of the first process by loading the first set of data, comprising the model and the set of weights for the model, into the second memory at the second node; and
wherein scheduling resumption of the first process comprises scheduling resumption of the first process at the second node based on the model and the set of weights for the model loaded into the second memory at the second node.

9. The method of claim 1:
wherein accessing the first policy comprises accessing the first policy defining the first set of parameters comprising a first target completion time for the job;
wherein accessing the second policy comprises receiving the second policy from a user, the second policy defining the second set of parameters comprising a second target completion time for the job, the second target completion time falling below the first target completion time; and
wherein selecting the selecting the second node comprises selecting the second node for the first process in response to receiving the second policy from the user and prior to completion of the job at the first node.

10. The method of claim 1:
wherein selecting the second node comprises:
generating a notification specifying a set of actions representing migration of a set of workloads from a first subset of nodes in the population of nodes to a second subset of nodes in the population of nodes, the set of workloads comprising the first process of the job, the first subset of nodes comprising the first node, the second subset of nodes comprising the second node; and
serving the notification to a user; and
wherein triggering the first checkpoint program to record the first state of the first process comprises triggering the first checkpoint program to record the first state of the first process in response to receiving confirmation of the set of actions by the user.

11. The method of claim 1:
wherein accessing the first policy for the job comprises accessing the first policy for the job comprising an inference job, the inference job comprising the first process;
wherein selecting the first node for the first process comprises:
accessing a first expected quantity of inference requests; and
selecting the first node for the first process based on:
the first set of parameters;
the first subset of performance characteristics for the first node;
the first objective function; and
the first expected quantity of inference requests; and
wherein selecting the second node for the first process comprises:
accessing a second expected quantity of inference requests, the second expected quantity of inference requests exceeding the first expected quantity of inference requests; and
o selecting the second node for the first process based on:
the second set of parameters;
the second subset of performance characteristics for the second node;
the second objective function; and
the second expected quantity of inference requests.

12. The method of claim 1, wherein accessing the first policy comprises:
accessing a template policy defining a set of template parameters;
accessing a set of modifications to the set of template parameters from a user;
transforming the set of template parameters into the first set of parameters based on the set of modifications; and
generating the first policy defining the first set of parameters.

13. The method of claim 1:
wherein selecting the second node comprises selecting the second node for the first process based on:
the second set of parameters;
the second subset of performance characteristics, in the second set of performance characteristics, for the second node;
the second objective function; and
a third set of parameters defined in a third policy for a second process of a second job executing within a first container instantiated at the second node;
wherein triggering the second checkpoint program to restore the first state of the first process comprises triggering the second checkpoint program to restore the first state of the first process at the second set of resources in the second node by loading the first set of data into the second memory for execution of the first process within a second container instantiated at the second node; and
wherein scheduling resumption of the first process at the second node comprises:
scheduling execution of the second process within the first container at the second node; and
scheduling resumption of the first process within the second container at the second node.

14. The method of claim 1:
wherein accessing the first policy for the job comprises accessing the first policy for the job comprising a model training job, the model training job comprising the first process;
wherein selecting the first node comprises selecting the first node comprising a first preemptible node, in the population of nodes, associated with a first remote contract computing network;
wherein scheduling execution of the first process at the first node comprises scheduling execution of the first process of the model training job at the first preemptible node;
wherein triggering the first checkpoint program executing at the first node to record the first state of the first process comprises, in response to detecting preemption of the first process at the first preemptible node by the first remote contract computing network, triggering the first checkpoint program executing at the first preemptible node to record the first state of the first process executing at the first preemptible node, the first state representing the first set of resources in the first preemptible node allocated to the first process of the model training job at the first time; and
wherein scheduling resumption of the first process at the second node comprises scheduling resumption of the first process of the model training job at the second node.

15. The method of claim 14:
wherein selecting the second node comprises selecting the second node comprising a second preemptible node associated with a second remote contract computing network different from the first remote contract computing network;
wherein triggering the second checkpoint program executing at the second node to restore the first state of the first process comprises triggering the second checkpoint program executing at the second preemptible node to restore the first state of the first process of the model training job at the second set of resources in the second preemptible node; and
wherein scheduling resumption of the first process at the second node comprises scheduling resumption of the first process of the model training job at the second preemptible node.

16. A method comprising:
during a first time period:
accessing a first set of parameters for a first job;
accessing a second set of parameters for a second job;
accessing a first set of performance characteristics representing a set of nodes for a first time interval;
based on the first set of parameters, the second set of parameters, and the first set of performance characteristics, calculating a first assignment of workloads to nodes in the set of nodes by:
selecting a first node, in the set of nodes, for a first process of the first job; and
selecting a second node in the set of nodes for a second process of the second job;
scheduling execution of the first process at the first node; and
scheduling execution of the second process at the second node; and
during a second time period succeeding the first time period:
accessing a third set of parameters for the second job;
accessing a second set of performance characteristics representing the set of nodes for a second time interval;
based on the first set of parameters, the third set of parameters, and the second set of performance characteristics, calculating a second assignment of workloads to nodes in the set of nodes by selecting the first node for a third process of the second job;
at a first checkpoint program executing at the first node:
recording a first state of the first process executing at the first node, the first state:
representing a first set of resources in the first node allocated to the first process at a first time; and
comprising a first set of call records representing a first set of calls to a first application programming of a first graphics processing unit in the first node; and
generating a first checkpoint object representing the first state of the first process at the first time;
terminating execution of the first process and the first checkpoint program at the first node;
at a second checkpoint program executing at the first node:
accessing a second checkpoint object representing a second state of the third process at a second time and comprising a second set of call records representing a second set of calls; and
restoring the second state of the third process at a second set of resources in the first node by executing the second set of calls to a second application programming interface of a second graphics processing unit in the first node; and
scheduling resumption of the third process at the first node in response to executing the second set of calls.

17. The method of claim 16:
wherein accessing the second set of parameters comprises accessing the second set of parameters comprising a first target processor capacity for the second job; and
wherein accessing the third set of parameters comprises:
accessing a set of execution characteristics representing resources allocated to the second process during execution of the second process at the second node, the set of execution characteristics representing a first processor utilization;
calculating a difference between the first processor utilization and the first target processor capacity; and
in response to the difference between the first processor utilization and the first target processor capacity exceeding a threshold amount, generating the third set of parameters representing a second target processor capacity for the second job.

18. The method of claim 16, further comprising, during a third time period succeeding the second time period:
accessing a third set of performance characteristics representing the set of nodes for a second time interval;
based on the first set of parameters, the third set of parameters, and the third set of performance characteristics, calculating a third assignment of workloads to nodes in the set of nodes by selecting the first node for the first process of the first job;
at a fourth checkpoint program executing at the first node:
accessing the first checkpoint object; and
restoring the first state of the first process at a third set of resources in the first node by executing the first set of calls to the first application programming interface of the first graphics processing unit in the first node; and
scheduling resumption of the first process at the first node in response to executing the first set of calls.

19. A method comprising:
accessing a first set of parameters for a model training job comprising a first process;
accessing a first set of performance characteristics representing a population of nodes for a first time interval;
selecting a first node, in the population of nodes, for the first process based on:
the first set of parameters; and
a first subset of performance characteristics, in the first set of performance characteristics, for the first node;
scheduling execution of the first process at the first node; and
in response to a change from the first set of parameters to a second set of parameters, different from the first set of parameters, for the model training job:
accessing a second set of performance characteristics representing the population of nodes for a second time interval;
prior to completion of the model training job, selecting a second node, in the population of nodes, for the first process based on:
the second set of parameters; and
a second subset of performance characteristics, in the second set of performance characteristics, for the second node;
triggering the first node to:
record a first state of the first process executing at the first node, the first state representing a first set of resources in the first node allocated to the first process at a first time; and
generate a first checkpoint object representing the first state of the first process at the first time;
triggering the second node to:
access the first checkpoint object; and
restore the first state of the first process at a second set of resources in the second node; and
scheduling resumption of the first process at the second node based on the first state of the first process.

20. The method of claim 19:
wherein triggering the first node to record the first state of the first process comprises triggering the first node to record the first state comprising a call record representing:
a call to a first application programming of a first graphics processing unit in the first node; and
a set of memory operations, associated with the call, for the first graphics processing unit;
wherein triggering the second node to restore the first state of the first process comprises triggering the second node to:
extract the call record from the first checkpoint object;
execute the call to a second application programming interface of a second graphics processing unit in the second node; and
execute the set of memory operations, associated with the call, for the second graphics processing unit; and
wherein scheduling resumption of the first process at the second node comprises scheduling resumption of the first process at the second node in response to:
execution of the set of calls to the second application programming interface of the second graphics processing unit; and
execution of the set of memory operations for the second graphics processing unit.
